(19) United States
(12) Patent Application Publication
(10) Pub. No.: US 2021/0274083 A1
(43) Pub. Date: Sep. 2, 2021

(54) METHOD FOR CONTROLLING AN ILLUMINATION OF AN OBJECT, SYSTEM FOR CONTROLLING AN ILLUMINATION OF AN OBJECT, AND CAMERA

(71) Applicant: OSRAM OLED GmbH, Regensburg (DE)

(72) Inventor: Stefan LORENZ, Schwarzenbruck (DE)

(21) Appl. No.: 17/274,048

(22) PCT Filed: Sep. 10, 2019
(86) PCT No.: PCT/EP2019/074121

§ 371 Date: Mar. 5, 2021

(30) Foreign Application Priority Data
Sep. 13, 2018 (DE) 102018122428.1

(51) Int. Cl. H04N 5/235; H05B 47/155; H05B 47/125

(52) U.S. Cl. CPC H04N 5/2354; H05B 47/125; H05B 47/155

(57) ABSTRACT

In at least one embodiment of the method for controlling an illumination of an object, the object is illuminated by a first radiation source during the method. A second radiation source is provided, the latter being configured to illuminate the object in addition to the first radiation source. The method comprises a step A), in which a first measurement signal is captured, wherein a change in the first measurement signal is representative for a change in a first radiation property of radiation striking the object. In a step B), the second radiation source is controlled, on the basis of a detected change in the first measurement signal, in such a way that the second radiation source illuminates the object and the change in the first radiation property of the radiation striking the object is counteracted.

A method for controlling an illumination of an object is specified. Furthermore, a system for controlling an illumination of an object and a camera are specified.

A problem to be solved is to specify a method for controlling an illumination of an object, with which unwanted temporal fluctuations in an illumination of an object can be at least partially avoided. Another task to be solved is to specify a system that can perform such a method. Still another task to be solved is to specify a camera comprising such a system.

These tasks are solved inter alia by the method and the objects of the independent patent claims and by the object of patent claim 17. Advantageous embodiments and further implementations are the subject matter of the dependent patent claims.

First, a method for controlling an illumination of an object is specified.

According to at least one embodiment, during the method the object is illuminated by a first radiation source. That is, the method steps of the method are performed while the first radiation source illuminates the object.

According to at least one embodiment, a second radiation source is provided for the method, which is configured to illuminate the object in addition to the first radiation source. The second radiation source is different from the first radiation source. The second radiation source illuminates the object when the second radiation source is controlled.

For example, the first radiation source and the second radiation source each emit electromagnetic radiation in the visible spectral range or in the infrared spectral range or in the UV range during operation. In particular, during operation, the second radiation source emits radiation in a spectral range that at least partially overlaps with a spectral range of the radiation emitted by the first radiation source. For example, at least 50% or at least 75% or at least 90% of the radiation emitted by the second radiation source is in a spectral range that is also emitted by the first radiation source.

The first radiation source is preferably an artificial radiation source, such as a luminaire. For example, the first radiation source comprises an incandescent lamp or one or a plurality of light emitting diodes or a discharge lamp, such as a fluorescent tube.

The object may be an object or a person or an entire scene. The fact that the second radiation source is configured to illuminate the object in addition to the first radiation source means in particular that the first radiation source and the second radiation source illuminate the same region or the same surface or partial surface of the object in the respective operation. That is, in operation of the first radiation source and in operation of the second radiation source, the illumination spots generated by the two radiation sources on the object partially or completely overlap with each other.

According to one embodiment, the method comprises a step A) in which a first measurement signal is detected, wherein a change in the first measurement signal is representative of a change in a first radiation property of radiation striking the object. In other words, a change in the first measurement signal correlates, in particular uniquely, with a change in the first radiation property of the radiation striking the object. Change here means a change over time. That is, in the case of a change, the first measurement signal or the first radiation property changes with time.

The first measurement signal can be an electronic signal, for example a digital or analog signal. For example, the detected first measurement signal is representative of the first radiation property of the radiation striking the object. That is, the first measurement signal carries information about the first radiation property. However, it is also possible for the first measurement signal to be representative only of the radiation from the first radiation source, as long as a change in the first measurement signal is representative of a change in the first radiation property of the radiation striking the object.

The first radiation property is a physical property, in particular an electromagnetic property, of the radiation striking the object, such as the intensity or the color or a coordinate of a chromaticity coordinate or the spectral distribution of the radiation.

For example, to detect the first measurement signal, a sensor is used on which radiation is striking. The first measurement signal is then generated from the radiation striking the sensor. In this case, the same radiation or at least a portion of the same radiation that strikes the object may also strike the sensor. For example, at least a portion of the radiation reflected from the object strikes the sensor. For this purpose, for example, a lens can be used that images a partial area of the illuminated area of the object onto the sensor.

However, the sensor may also be used to detect radiation other than that striking the object, wherein a change in the first radiation property of the other radiation is representative of a change in the radiation striking the object. For example, the sensor is arranged adjacent to the object or on the object. The sensor may also be arranged outside the illumination area/illumination spot of the second radiation source, for example only in the illumination area/illumination spot of the first radiation source.

The fact that a change in the first measurement signal is representative of a change in the first radiation property means that a change in the first radiation property correlates, in particular one-to-one correlates, with a change in the first measurement signal. For example, a change in the first measurement signal can be unambiguously concluded to be a change in the first radiation property, and vice versa. A change in the first measurement signal is, for example, a change in an amplitude or a value of the first measurement signal.

In step A), the object may initially be illuminated exclusively by the first radiation source. Alternatively, however, it is also possible that in step A) the second radiation source already additionally illuminates the object. The first measurement signal detected in step A) or its change can therefore either be representative only of the first radiation property of the radiation emitted by the first radiation source or its change. Alternatively, the first measurement signal or its change may be representative of the first radiation property of the radiation resulting from the temporal and/or local superposition of the radiations from the first radiation source and the second radiation source or its change.

According to at least one embodiment, the method comprises a step B) in which the radiation source is controlled as a function of a detected change in the first measurement signal in such a way that the second radiation source illuminates the object and the change in the first radiation property of the radiation striking the object is counteracted. For example, step B) is executed only when a detected change in the first measurement signal exceeds or falls below a predetermined threshold.

In other words, if a change in the first measurement signal is detected, in step B) the second radiation source is controlled in such a way that the correlated change in the first radiation property is counteracted or this change in the first radiation property is partially or completely compensated. Preferably, however, the change in the first radiation property is not overcompensated.

By controlling the second radiation source in step B), the object is illuminated by both the first radiation source and the second radiation source. When controlling the second radiation source, the first radiation source and the second radiation source can illuminate the object simultaneously or alternately. Preferably, the second radiation source is controlled by a control device.

The control of the second radiation source in response to a detected change in the first measurement signal may be delayed with respect to the detected change in the first measurement signal. For example, the delay may be at least 0.1 s. Preferably, however, the delay is at most 2 s. Consequently, the first radiation characteristic of the radiation striking the object changes before this change is counteracted by controlling the radiation source. In other words, in this case the first measurement signal is acquired in step A) for a first period of time. If a change in the first measurement signal is detected during this period, the second radiation source is controlled for a subsequent, second period in such a way that the previous change in the first radiation property of the radiation striking the object is counteracted.

However, the second radiation source can also be controlled simultaneously or almost simultaneously with the detection of the change in the first measurement signal. For example, the second radiation source is controlled depending on the detected change in the first measurement signal at the latest 1 ms or at the latest 1 μs after the change in the first measurement signal is detected.

The change in the first measurement signal can be a periodic or aperiodic change. In the case of a periodic change, the control of the second radiation source then preferably also takes place periodically. In the case of an aperiodic change, the activation of the second radiation source is then preferably also aperiodic.

Step B) may comprise several sub-steps. For example, in a substep B1), a change in the first measurement signal can first be determined as a function of the detected first measurement signal. The determination of the change in the first measurement signal can be performed, for example, by means of a processor. For example, the detected first measurement signal is compared with a previously detected first measurement signal for this purpose. A deviation from the preceding first measurement signal can then be evaluated as a change in the first measurement signal. In a subsequent substep B2), a control signal can be determined with the aid of which the radiation source is controlled so that the change in the first radiation property is counteracted.

Alternatively, however, it is possible that the change in the first measurement signal is not determined separately. For example, the first measurement signal is an analog signal that is used immediately or after amplification or adaptation as a control signal for controlling the radiation source.

Step A) is preferably carried out continuously or repeatedly. That is, the first measurement signal is acquired continuously or repeatedly. If a change in the first measurement signal, which exceeds a predetermined threshold, for example, occurs again after step B), step B) is preferably executed again to readjust the radiation source.

In particular, therefore, a loop with any number of repetitions of steps A) and B) can be executed.

In at least one embodiment of the method for controlling an illumination of an object, the object is illuminated by a first radiation source during the method. A second radiation source is provided that is configured to illuminate the object in addition to the first radiation source. The method comprises a step A) in which a first measurement signal is detected, wherein a change in the first measurement signal is representative of a change in a first radiation property of a radiation striking the object. In a step B), the second radiation source is controlled in response to a detected change in the first measurement signal such that the second radiation source illuminates the object and the change in the first radiation property of radiation striking the object is counteracted.

The present invention is based inter alia on the realization that many modern and classical light sources do not emit a continuous luminous flux, but modulated luminous fluxes, with repetition rates of the mains frequency of, for example, 50 Hz, 60 Hz, 100 Hz, 120 Hz or higher rates. The effects of such modulated luminous fluxes may be visible and perceptible to an observer directly, for example by flicker, or indirectly, for example by spatial modulation, fatigue phenomena, double images, et cetera.

In the present invention, use is made, inter alia, of the idea of creating a region of “visual quiet” in which existing modulations of a first radiation source are compensated. The equalizing is done, for example, by selective counter-modulation with a second radiation source. The modulation can be, for example, a modulation in intensity or color. Counter-modulation can be used to achieve a visually quieted zone, for example on a table surface, or better image quality on a camera. The first radiation source may be inexpensive, since modulation of the radiation from this first radiation source can be compensated for by the present method.

In addition to the first measurement signal, the method may also acquire one or more further measurement signals. Changes in the further measurement signals are then preferably representative in each case of a change in further radiation properties. By detecting a change in the respective further measurement signals and corresponding control of the second radiation source or further radiation sources, the correlated changes in the associated further radiation properties can be counteracted. All specifications made here and in the following in connection with the first measurement signal and the first radiation property may also apply to the further measurement signals and further radiation properties.

According to at least one embodiment, the first measurement signal is acquired at an acquisition rate or sampling rate of at least 50 Hz. Preferably, the first measurement signal is acquired at an acquisition rate of at least 100 Hz or at least 1000 Hz. Alternatively or additionally, the first measurement signal may be acquired at an acquisition rate of at most 10 kHz or at most 5 kHz. However, it is also possible that the first measurement signal is acquired continuously. In particular, an acquisition rate that is greater than an expected average rate or frequency of change in the first radiation property is advantageous for capturing the changes in the first radiation property.

According to at least one embodiment, the first radiation property is the intensity or the color or a chromaticity coordinate or the intensity of a spectral portion of the radiation striking the object. Color is understood to mean, in particular, the color impression that the radiation evokes in an observer.

Further, any radiometric or photometric parameter can be the first radiation property. For example, the first radiation property is the radiant flux or luminous flux or radiance or luminance or radiant intensity or luminosity or irradiance or illuminance.

For example, if the intensity of the radiation emitted by the first radiation source and striking the object periodically increases and decreases, the second radiation source can be controlled such that the intensity of the radiation emitted by the second radiation source and striking the object periodically decreases and increases in phase opposition. For example, if the color of the radiation emitted by the first radiation source changes, a light emitting diode of the second radiation source is added or removed to compensate for this color change.

According to at least one embodiment, in step B) the second radiation source is controlled with a periodically modulated control signal. The amplitude of the modulation and/or the frequency of the modulation of the control signal are thereby adapted to the detected change of the first measurement signal. In particular, in the case of a periodically modulated first measurement signal, the variation of the control signal comprises the same period or frequency.

To determine the frequency of the control signal, for example, the first measurement signal is acquired over a first period. Based on the detected first measurement signal, a frequency of the modulation of the first measurement signal may be determined or detected. The second radiation source can then be controlled modulated at the same frequency.

According to at least one embodiment, the second radiation source is controlled in step B) in such a way that a subsequently detected first measurement signal deviates by at most 20% or by at most 5% from a predetermined setpoint value. The setpoint value can be a value of the first measurement signal before the change in the first measurement signal has taken place. However, the setpoint value may also be a time average value of the first measurement signal, for example averaged over a period of at least 1/10 s or 0.5 s or 1 s. For example, a detected periodic fluctuation of the first measurement signal is counteracted by step B) to such an extent that, after step B), a fluctuation of the detected, first measurement signal about the mean value is at most 20%.

According to at least one embodiment, an area of the object illuminated by the first radiation source during operation and an area of the object illuminated by the second radiation source during operation overlap in an intersection area of at least 0.1 m² or at least 1 m². Alternatively or additionally, the intersection area may be at most 20 m² or at most 10 m². In particular, the areas of the object illuminated by the first radiation source and the second radiation source are the illumination spots on the object generated by the first radiation source and the second radiation source.

According to at least one embodiment, a sensor, for example a photodiode or a CMOS sensor or a CCD sensor, is used to detect the first measurement signal in step A).

According to at least one embodiment, the second radiation source comprises one or a plurality of light emitting diodes. For example, the second radiation source comprises light emitting diodes that emit radiation of different wavelength ranges during operation. For example, the second radiation source comprises at least three light emitting diodes, wherein a first light emitting diode emits blue light during operation, a second light emitting diode emits green light during operation, and a third light emitting diode emits red light during operation. Such a second radiation source can be used, for example, to partially or fully compensate for changes in the color of the radiation striking the object.

According to at least one embodiment, the first radiation source is a luminaire or a screen. For example, the first radiation source is an indoor light, such as a ceiling light or a desk light, or a television screen or a computer screen.

According to at least one embodiment, the object is at rest during intended operation. Thus, in the intended operation of the object, the object is not moved. For example, the object is a table top or table surface. If the table top is illuminated, for example, by a flickering room light, the flickering can be compensated for by appropriately controlling the second radiation source so that the light reflected from the table top does not flicker.

According to at least one embodiment, the object performs a periodic motion during intended operation. For example, the object is an element of a machine, wherein the element rotates or oscillates. For example, the object is a rotating element of a lathe or a propeller blade or rotor blade. For example, if the periodically moving element is illuminated by a first radiation source that flickers at the same frequency as the object periodically moves, a stroboscopic effect can occur in which it appears to the viewer that the object is not moving. With the method described herein, such a stroboscopic effect can be counteracted, which significantly reduces a hazard when using the machine.

According to at least one embodiment, the second radiation source is a radiation source for a camera. For example, the second radiation source is a flash light or a headlight for a camera. The second radiation source may be part of the camera, for example, it may be mounted in or on a housing of the camera. However, the second radiation source can also be a separate element from the camera, for example an external headlight.

The camera may be used to capture an image that is illuminated by a first radiation source, for example a flickering radiation source. By controlling the second radiation source, the flicker can be compensated and the quality of the captured image can be increased. The camera may be a still camera or video camera. The camera may be a digital camera, for example of a cell phone.

According to at least one embodiment, the first radiation source and the second radiation source each emit light in the visible spectral range during operation. Alternatively, it is also conceivable that the first radiation source and the second radiation source each emit light in the infrared spectral range or in the UV range.

According to at least one embodiment, the second radiation source is configured to provide a higher radiation intensity than the first radiation source at least at one wavelength. For example, the second radiation source is configured to provide a higher intensity at the wavelength at which the first radiation source comprises a maximum intensity. Preferably, the second radiation source is configured to provide a higher intensity than the first radiation source over a majority of the spectral range emitted by the first radiation source. This allows changes in the first radiation property of the first radiation source to be fully compensated for using the second radiation source.

Next, the system for controlling an illumination of an object is specified. In particular, the system is configured to perform a method as described above. Therefore, all features disclosed in connection with the method are also disclosed for the system and vice versa.

According to at least one embodiment, the system for controlling an illumination of an object comprises a second radiation source configured to illuminate the object. Further, the system comprises a sensor configured to detect a first measurement signal, wherein a change in the first measurement signal is representative of a change in a first radiation property of a radiation striking the object. The system comprises a control device configured to generate a control signal in response to a detected change in the first measurement signal, and to control the second radiation source with the control signal. The system is thereby configured such that by controlling the second radiation source with the control signal, the second radiation source illuminates the object while counteracting the change in the first radiation characteristic of the radiation striking the object.

According to at least one embodiment, the second radiation source is a luminaire, such as a table lamp.

Next, the camera is specified. The camera comprises a system as described above. Therefore, all features disclosed in connection with the system are also disclosed for the camera, and vice versa.

In addition to the system for controlling an illumination of an object, the camera includes, for example, an image sensor for capturing an image and a lens for focusing radiation onto the image sensor.

In the following, a method described herein for controlling an illumination of an object as well as a system described herein for controlling an illumination of an object as well as a camera will be explained in more detail with reference to drawings based on exemplary embodiments. Identical reference signs thereby specify identical elements in the individual figures. However, no scale references are shown, rather individual elements may be shown exaggeratedly large for better understanding.

It shows:

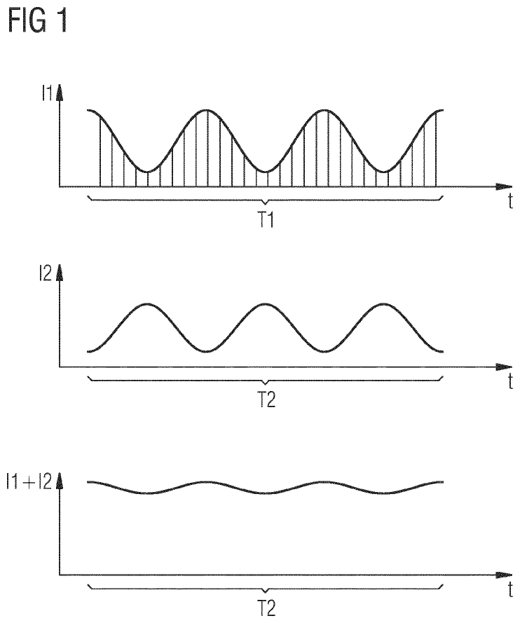

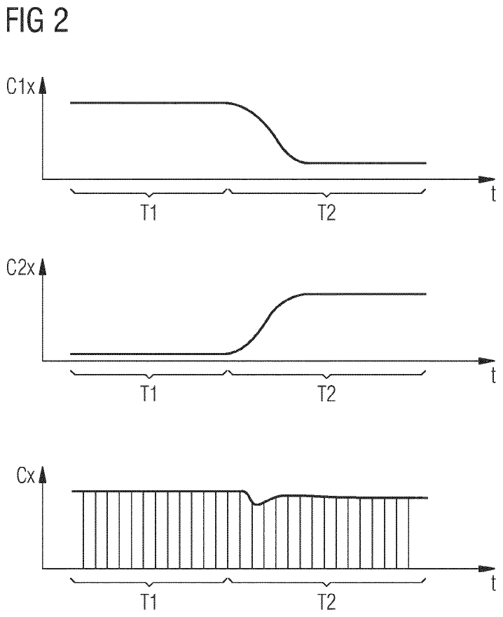

FIGS. 1 and 2 exemplary embodiments of the method based on diagrams,

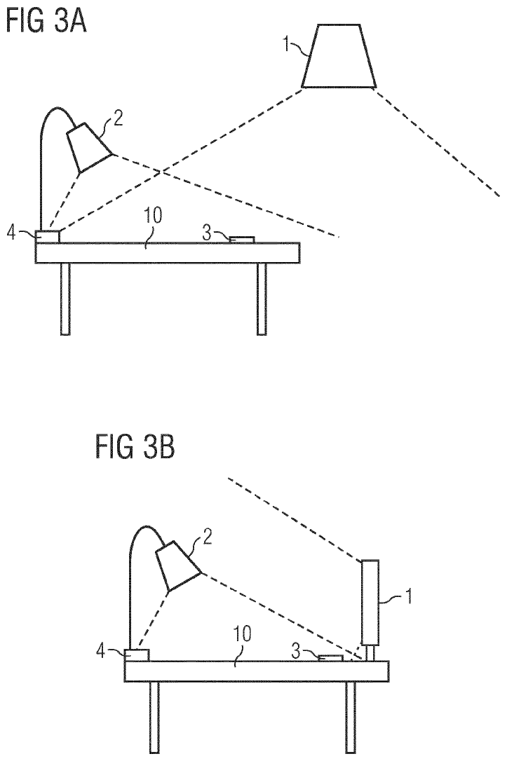

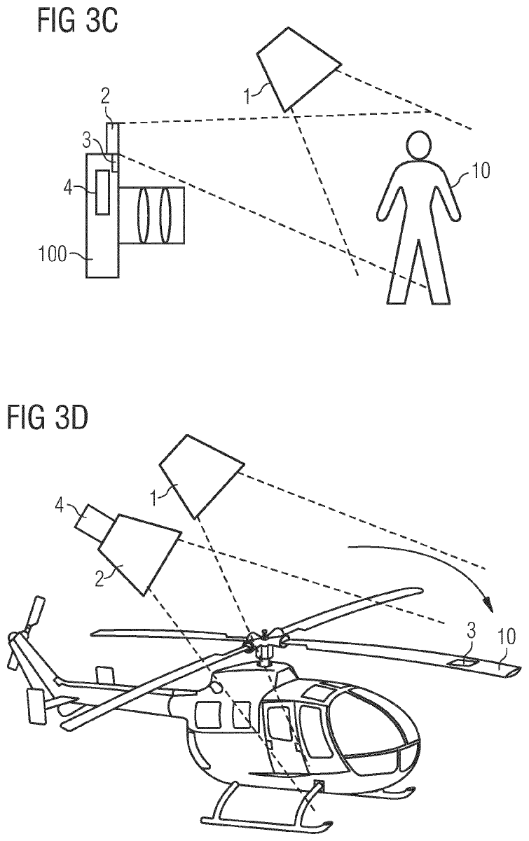

FIGS. 3A to 3D exemplary embodiments of the system and an exemplary embodiment of the camera.

In FIG. 1, a first exemplary embodiment of the method by means of three diagrams is shown. An object, for example a table surface, is illuminated by a first radiation source. In the uppermost diagram, a first radiation property I1 of the radiation striking the object as a function of time t is shown. The first radiation property I1 is the intensity of the radiation striking the object. However, it could also be the intensity of only one spectral portion.

In the uppermost diagram of FIG. 1 it can be seen that the intensity I1 is subject to a periodic modulation or change, which is due, for example, to the operation of the first radiation source with alternating current of 50 Hz. In the uppermost diagram of FIG. 1, the course of the intensity I1 over a period of time T1 is shown. For example, the object is illuminated only by the first radiation source during the time period T1.

In the method, a first measurement signal is now acquired which is representative of the intensity I1. The first measurement signal is shown as vertical lines in the uppermost diagram of FIG. 1. The first measurement signal is acquired at an acquisition rate that is greater than the frequency of the modulation of intensity I1. For example, the acquisition rate is between and including 1 kHz and 3 kHz. Because of the high acquisition rate of the first measurement signal, a change in the first measurement signal is detectable that is representative of the change in intensity I1. That is, the change in the first measurement signal correlates one-to-one with the change in intensity I1 of the radiation striking the object.

Depending on the detected change in the first measurement signal, a second radiation source is now controlled in such a way that the second radiation source illuminates the object together with the first radiation source. The first radiation characteristic I2, in this case the intensity of the radiation striking the object emitted by the second radiation source, for a time period T2 is shown in the middle diagram of FIG. 1. The time span T2 follows the time span T1.

In the middle diagram, it can be seen that the second radiation source is controlled in such a way that the intensity I2 is also subject to periodic modulation. The control is selected in such a way that the periodic modulation comprises the same or nearly the same frequency as the periodic modulation of the intensity I1 in the upper diagram. However, the modulation is out of phase so that the intensity I2 attributable to the second radiation source comprises a maximum when the intensity I1 attributable to the first radiation source comprises a minimum.

The first radiation source and the second radiation source irradiate the same region of the object during the time period T2. The mixed radiation hitting this area, respectively the intensity I1+I2 of this mixed radiation on the object, is shown in the lowest diagram of FIG. 1. Due to the superposition of the radiations of the first radiation source and the second radiation source, the modulation present during the time period T1 is now almost completely compensated.

Overall, therefore, the second radiation source is controlled in the second time period T2 in such a way that the change in intensity I1 occurring during the time period T1 is counteracted.

Should there be a renewed change in the intensity I1+I2 of the radiation striking the object after the time period T2, the second radiation source can be readjusted to counteract this change as well.

In the FIG. 2, second exemplary embodiment of the method by means of diagrams is shown. Again, an object, for example a table top, is illuminated by a first radiation source. The first radiation source is, for example, a computer monitor.

In the uppermost diagram of FIG. 2, a first radiation property C1x, in this case a color coordinate, of the radiation striking the object from the first radiation source is shown as a function of time. It can be seen that the color coordinate C1x of the radiation from the first radiation source is constant over a time period T1 and initially decreases after the time period T1, in a time period T2, and is then constantly lower than in the first time period T1. This may be the case, for example, when a user switches back and forth between two computer programs, causing the color emitted by the screen to change.

In the middle diagram of FIG. 2, the color coordinate C2x of the radiation from a second radiation source is shown, with which the second radiation source illuminates the object. The second radiation source emits radiation in the first time period T1, wherein the color coordinates C2x is low. In the time period T2 the value of the color coordinates C2x of the radiation emitted by the second radiation source increases.

In the lowest diagram of FIG. 2, color coordinate Cx of the total radiation striking the object by superposition of the radiations from the first radiation source and the second radiation source is shown as a function of time t. Also shown is a detected first measurement signal (vertical lines), wherein the first measurement signal is representative of the color coordinate Cx of the radiation striking the object. A change in the first measurement signal clearly correlates with the change in the color coordinate Cx of the radiation striking the object.

It can be seen that a change in the first measurement signal correlates to the decrease in the value of the color coordinates C1x of the radiation from the first radiation source. As a result, the second radiation source was controlled in such a way that this decrease was compensated almost immediately, so that the color coordinates Cx of the total radiation striking the object is almost constant in the time periods T1 and T2.

In the FIG. 3A, a first exemplary embodiment of the system for controlling the illumination of an object is shown. In the present case, the object 10 is a desk top. The system comprises a second radiation source 2, in this case a desk lamp. The second radiation source 2 illuminates the object 10. The object 10 is also illuminated by a first radiation source 1, presently a ceiling lamp. The illumination spots generated by the first radiation source 1 and the second radiation source 2 (dashed lines) overlap on the object 10.

The system further comprises a sensor 3 arranged in the overlapping area of the two illumination spots on the object 10. However, the sensor 3 could also be arranged outside the overlapping area, for example only in the illumination spot of the first radiation source 1. The sensor 3 is, for example, a photodiode. The sensor 3 is configured to detect a first measurement signal. A change in the first measurement signal is thereby representative of a change in a first radiation property of the radiation striking the object 10 from the two radiation sources 1, 2.

Furthermore, the system comprises a control device 4 which is configured to generate a control signal in dependence on a detected change of the first measurement signal and thus to control the second radiation source 2. The control device 4 additionally comprises, for example, a processor to determine a change in the first measurement signal and/or to calculate the control signal.

Overall, the system comprising the second radiation source 2, the sensor 3 and the control device 4 is configured such that by controlling the second radiation source with the control signal, the second radiation source 2 illuminates the object 10 while counteracting the change in the first radiation property of the radiation striking the object. For example, the system can then be used to counteract flicker of the ceiling light 1. The total radiation reflected from the desk 10 that is perceived by an observer is then free of the flicker.

In the FIG. 3B, again the exemplary embodiment of the system of FIG. 3A is shown. In contrast to FIG. 3A, however, the first radiation source 1 is now not a ceiling light, but a screen, for example a computer screen. If a user of the computer changes the computer program, for example, the color of light emitted from the screen to the desk may change. Accordingly, the light reflected from the desk would also change color, which may be distracting to an observer. With the system, the desk can be illuminated with the second radiation source 2 in such a way that this color change is counteracted and the overall light color reflected from the desk does not change.

In the FIG. 3C, an exemplary embodiment of the camera 100 comprising an embodiment of the system is shown. The camera 100 is intended to record an object 10, presently a person 10. The person 10 is illuminated by a first radiation source 1, such as a headlight. The radiation emitted by the headlight 1 may comprise intensity fluctuations due to mains operation, which may have a negative effect on the image quality. The system incorporated in the camera 100 can compensate for this intensity fluctuation. Radiation reflected from the person 10 hits the sensor 3, and the sensor 3 detects a first measurement signal. A change in the first measurement signal is representative of the change in radiation intensity striking the person 10. Accordingly, a second radiation source 2, which is for example the flash of the camera 100, is then controlled to compensate for this change in the radiation intensity striking the person 10. This may increase the quality of the image captured by the camera 100.

In the FIG. 3D, another exemplary embodiment of the system is shown. Again, the system comprises a second radiation source 2, for example a headlight, a control device 4 for controlling the second radiation source 2 and a sensor 3. The second radiation source 2 together with a first radiation source 1 in the present case illuminate a helicopter, for example a model helicopter. The first radiation source 1 and the second radiation source 2 are intended to illuminate an object 10, in this case a periodically rotating rotor blade 10 of the helicopter.

For example, the radiation emitted by the radiation source 1 is subject to periodic intensity modulation. If the rotor blade 10 happens to rotate at the same frequency as the intensity modulation, it may appear to an observer that the rotor blade 10 is not rotating. This could be associated with significant hazards to the observer, for example, if the observer attempts to touch the rotor blade 10.

The system reduces this danger. The sensor 3 is arranged on the rotor blade 10. Radiation from the two radiation sources 1, 2 strikes on the sensor 3, which detects a first measurement signal. A change in the first measurement signal is representative of a change in the radiation intensity striking the rotor blade 10. Depending on the detected change in the first measurement signal, the second radiation source 2 is controlled via the control device 4. The second radiation source 2 then emits radiation with an intensity modulation that partially or completely compensates for the intensity modulation of the first radiation source 1. As a result, the rotor blade 10 appears to be rotating rather than stationary.

Other than shown in FIG. 3D, the sensor can also be arranged on a non-rotating part, for example on the rotor axis.

This patent application claims priority to German patent application 10 2018 122 428.1, the disclosure content of which is hereby incorporated by reference.

The invention is not limited to the embodiments by the description based thereon. Rather, the invention encompasses any new feature as well as any combination of features, which in particular includes any combination of features in the patent claims, even if these features or this combination itself is not explicitly stated in the patent claims or embodiments.

### LIST OF REFERENCE SIGNS

1 first radiation source

2 second radiation source

3 sensor

4 control device

10 object

100 camera

1. Method for controlling an illumination of an object, wherein
during the method, the object is illuminated by a first radiation source,
a second radiation source is provided, which is configured to illuminate the object (10) in addition to the first radiation source,
the method comprises the steps of:
A) detecting a first measurement signal, wherein a change in the first measurement signal is representative of a change in a first radiation property of a radiation striking the object, wherein
to detect the first measurement signal in step A), a sensor is used on which radiation is striking, and
the first measurement signal is then generated from the radiation striking the sensor;
B) controlling the second radiation source in response to a detected change in the first measurement signal such that the second radiation source illuminates the object and the change in the first radiation property of radiation striking the object is counteracted, wherein
the second radiation source is controlled with a periodically modulated control signal, and
the amplitude of the modulation and the frequency of the modulation of the control signal are adapted to the detected change of the first measurement signal.

2. Method according to claim 1,
wherein the first measurement signal is acquired at an acquisition rate of at least 50 Hz.

3. Method according to claim 1,
wherein the first radiation property is the intensity or the color or the intensity of a spectral portion of the radiation striking the object.

4. (canceled)

5. Method according to claim 1,
wherein in step B) the second radiation source is controlled in such a way that a subsequently detected first measurement signal deviates by at most 20% from a predetermined setpoint value.

6. Method according to claim 1,
wherein an area of the object illuminated by the first radiation source during operation and an area of the object illuminated by the second radiation source during operation overlap with each other in an intersection area of at least 0.1 m².

7. Method according to claim 1,
wherein a sensor is used to detect the first measurement signal in step A).

8. Method according to claim 1,
wherein the second radiation source comprises one or a plurality of light emitting diodes.

9. Method according to claim 1,
wherein the first radiation source is a luminaire or a screen.

10. Method according to claim 1,
wherein the object is at rest during intended operation.

11. Method according to claim 1,
wherein the object performs a periodic movement in the intended operation.

12. Method according to claim 1,
wherein the second radiation source is a radiation source for a camera.

13. Method according to claim 1,
wherein the first radiation source and the second radiation source each emit light in the visible spectral range during operation.

14. Method according to claim 1,
wherein the second radiation source is configured to provide a higher radiation intensity than the first radiation source at least at one wavelength.

15. System for controlling an illumination of an object, comprising:
a second radiation source configured to illuminate the object,
a sensor configured to detect a first measurement signal, which is generated from a radiation striking the sensor, wherein a change in the first measurement signal is representative of a change in a first radiation property of a radiation striking the object,
a control device configured to generate a periodically modulated control signal in response to a detected change in the first measurement signal and to control the second radiation source with the control signal, wherein
the system is configured such that by controlling the second radiation source with the control signal, the second radiation source illuminates the object while counteracting the change in the first radiation property of the radiation striking the object, wherein the amplitude of the modulation and the frequency of the modulation of the control signal are adapted to a detected change of the first measurement signal.

16. System according to claim 15,
wherein the second radiation source is a luminaire.

17. Camera comprising a system according to claim 15.
